(19) United States
(12) Patent Application Publication
(10) Pub. No.: US 2009/0133034 A1
(43) Pub. Date: May 21, 2009

(54) Screened participant class notification for public networks

(75) Inventor: Derek M. Hazeur, Redmond, WA (US)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 11/940,713

(22) Filed: Nov. 15, 2007

(51) Int. Cl. G06F 9/44

(52) U.S. Cl. 719/313

(57) ABSTRACT

Screened participant classes are established that enable a communication participant notification continuum which may be utilized to facilitate appropriate notification of a particular computer facilitated communication participant's legal status and/or subject matter sensitivities to computer facilitated communication service providers and/or other communication participants. For example, a level of participant class screening may be adjusted depending on a level of trust and/or communication history with a particular communication participant. Screened participant classes may be associated with particular communication devices and/or communication device users. Once notified with a set of screened participant classes, the notified communication participant may adjust subject matter that is communicated to the notifying communication participant based on the set of screened participant classes. Such adjustment may include simple access control and subject matter filtering as well as more sophisticated participant routing based on screened participant class set compatibility.

### BACKGROUND

It has become commonplace for people to use computer networks to communicate and collaborate. Such computer facilitated communication may support a variety of communication modes from simple text exchange to rich media environments that include audio, video and animation, from one-to-one through to many-to-many, from largely unidirectional to fully interactive, from casual to formal, and from private to public. Of course communication is a very human activity and has a long moral and legal history associated with its various modes and forms. However, particularly in that context, computer facilitated communication may be disruptive.

For example, a typical level of anonymity of participants in a computer facilitated communication may result in one participant unintentionally offending another by communicating subject matter that is inappropriate for the recipient. Such offense may range from merely being undesirable through to having serious legal consequences for the author of the communication. Depending on the mode of communication, attempts to avoid offending or being offended may range from awkward through to nigh on impossible, and this is for well-intentioned participants. Computer networks, and public computer networks in particular, may also include malicious participants seeking to intentionally offend and worse.

Some attempts to address the situation ask communication authors to associate metadata with communication subject matter that describes various ways in which the subject matter may offend and/or be inappropriate for recipients. However, levels of compliance with such schemes is typically low, even for more formal communication modes such as publication of hypertext documents (e.g., “web pages”), and can be burdensome for more casual communication modes. Furthermore, even well-intentioned authors may be unaware of, or misinformed with regard to, audience sensitivities, particularly in the context of a computer network with worldwide and/or multicultural scope. Ill-intentioned authors may provide deceptive metadata.

Some authors and/or publishers, particularly those of communications involving controversial and/or legally regulated subject matter, require recipients to verify biographic details such as date of birth, for example, with government-issued photo identification or an electronic equivalent thereof. While methods exist to ease such verification, conventional schemes have fallen short of the wide adoption that seems necessary to prevent such verification requirements being an undesirable obstacle to communication. Furthermore, there may be privacy issues, and even safety issues, involved in disclosing detailed biographical data to other computer facilitated communication participants, particularly those without previous communication history.

### SUMMARY

A set of screened participant classes are established that enable a communication participant notification continuum that includes partial or screened notification, as well as the extremes of no notification and full or detailed notification. The notification continuum may be utilized to facilitate appropriate notification of a particular computer facilitated communication participant's legal status and/or subject matter sensitivities to computer facilitated communication service providers and/or other communication participants. For example, a level of participant class screening may be adjusted depending on a level of trust and/or communication history with a particular communication participant.

Screened participant classes may be associated with particular communication devices and/or communication device users. Such associations may be made with a graphical user interface. Outgoing communication requests and/or communication protocol messages may be intercepted, and unobtrusively injected with screened participant class notifications. Protocol message recipients may parse received protocol messages for screened participant class notifications associated with the sender. Once notified with a set of screened participant classes, the notified communication participant may adjust subject matter that is communicated to the notifying communication participant based on the set of screened participant classes. Such adjustment may include simple access control and subject matter filtering as well as more sophisticated participant routing based on screened participant class set compatibility.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

### BRIEF DESCRIPTION OF THE DRAWINGS

FIG. 1 is a schematic diagram depicting an example computing environment in accordance with an embodiment of the invention.

FIG. 2 is a schematic diagram depicting an example high level screened participant class notification architecture in accordance with an embodiment of the invention.

FIG. 3 is a schematic diagram depicting an example screened participant class publisher in accordance with an embodiment of the invention.

FIG. 4 is a schematic diagram depicting an example screened participant class consumer in accordance with an embodiment of the invention.

FIG. 5 is a schematic diagram depicting an example protocol message incorporating a screened participant class notification in accordance with an embodiment of the invention.

FIG. 6 is a flowchart depicting example steps for configuring the screened participant class publisher in accordance with an embodiment of the invention.

FIG. 7 is a flowchart depicting example steps for publishing screened participant class notifications in accordance with an embodiment of the invention.

FIG. 8 is a flowchart depicting example steps for service access control based on screened participant class(es) in accordance with an embodiment of the invention.

FIG. 9 is a flowchart depicting example steps for profile consistency verification based on screened participant class(es) in accordance with an embodiment of the invention.

FIG. 10 is a flowchart depicting example steps for facilitated group joining based on screened participant class(es) in accordance with an embodiment of the invention.

The same numbers are used throughout the disclosure and figures to reference like components and features.

### DETAILED DESCRIPTION

In an embodiment of the invention, a set of screened participant classes (SPCs) are established to enable a communication participant notification continuum that includes partial or screened notification, as well as the extremes of no notification and full or detailed notification. The notification continuum may be utilized to facilitate appropriate notification of a particular computer facilitated communication participant's legal status and/or subject matter sensitivities to computer facilitated communication service providers and/or other communication participants (“communication participants”). For example, a level of participant class screening may be adjusted (e.g., an appropriate screened participant class may be selected) depending on a level of trust and/or communication history (“trust”) with a particular communication participant.

As a more specific example, a communication device of a 12 year old may be configured to notify one set of communication participants with a screened participant class corresponding to “participant's age is in the range 11-12 years old,” to notify another set of communication participants with a screened participant class corresponding to “participant is a preteen,” and to notify yet another set of communication participants with a screened participant class corresponding to “participant is under 18 years old.” In each case, the notified parties are put on notice with regard to the 12 year old's legal status without divulging biographic details at an undesirable level of specificity. Sets of communication participants notified with more specific screened participant classes may be associated with higher levels of trust relative to sets of communication participants notified with less specific screened participant classes.

Screened participant classes may be associated with particular communication devices and/or communication device users. Such associations may be made with a graphical user interface (GUI). User interface names and/or representations of screened participant classes may be tailored for ease of configuration and need not correspond one-to-one with ultimately associated set of screened user classes. Outgoing communication requests and/or communication protocol messages (“protocol messages”) may be intercepted, and unobtrusively injected with screened participant class notifications. For example, screened participant class notifications may be injected into communication protocol message headers. Protocol message recipients may parse received protocol messages for screened participant class notifications associated with the sender.

Once notified with a set of screened participant classes, the notified communication participant may adjust subject matter that is communicated to the notifying communication participant based on the set of screened participant classes. Such adjustment may include simple access control and subject matter filtering as well as more sophisticated participant routing based on screened participant classes. For example, a particular computer facilitated communication participant may be directed to one of a set of communication services based on a match between screened participant classes associated with the participant and screened participant classes associated with the service. In particular, the participant may be directed to one of a set of discussion groups that best matches the screened participant classes associated with the participant. Computer facilitated communication providers may also ensure that service profiles created by participants are consistent with screened participant classes associated with participants.

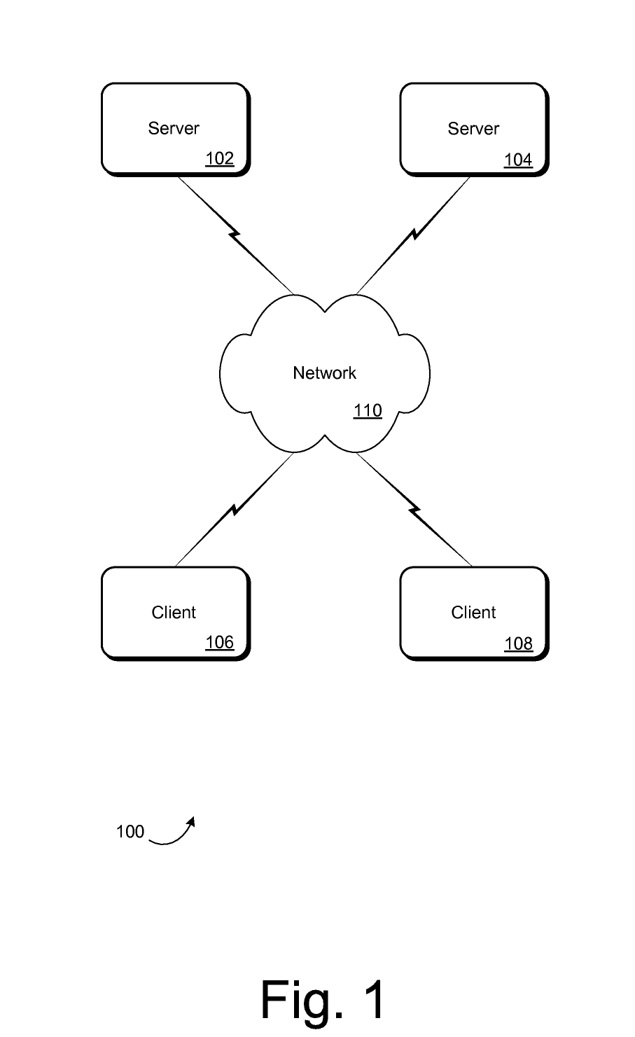

Before describing aspects of screened participant class notification in accordance with an embodiment to the invention in more detail, it will be helpful to have reference to an example computing environment suitable for incorporating such. FIG. 1 depicts a suitable computing environment 100. The computing environment 100 depicts four computers 102, 104, 106, 108 connected by a network 110. For clarity, two of the computers 102, 104 are designated as servers, and two of the computers 106, 108 are designated as clients. Embodiments of the invention are not so limited and may include any suitable number of computers, servers and/or clients. Furthermore, as will be apparent to one of skill in the art, any of the computers 102, 104, 106, 108 may perform in multiple roles so that, for example, the computer 104 may change roles to become a client or act as both server and client simultaneously.

The computers 102, 104, 106, 108 may be any suitable computing device. Examples of suitable computing devices include mainframes, minicomputers, desktop computers, personal computers (PCs), workstations, portable computers, laptop computers, tablet computers, personal digital assistants (PDAs), mobile telephones, programmable consumer electronics devices, routers, gateways, switches, hubs, and suitable combinations thereof. For the purposes of this description, the term “communication device” may be understood as meaning “computing device capable of facilitating communication” unless clearly contradicted by context.

The computers 102, 104, 106, 108 may include one or more processing units capable of executing instructions to perform tasks, as well as one or more types of computer-readable media such as volatile and/or non-volatile memory capable of storing data, computer programs and/or computer program components. Such computer programs and components may include executable instructions, structured data and/or unstructured data organized into modules, routines and/or any suitable programmatic object. Such computer programs and components may be created by and/or incorporate any suitable computer programming language.

The computers 102, 104, 106, 108 may include a wide variety of input/output (I/O) devices not shown in FIG. 1 such as keyboards, keypads, touchpads, mice, trackballs, pens, joysticks, gamepads, scanners, cameras, microphones, monitors, liquid crystal displays (LCDs), light emitting diodes (LEDs), printers and/or speakers. Examples of computer-readable media suitable for reading by the computers 102, 104, 106, 108 include any one or more of magnetic media (such as hard disks), optical media such as compact disks (CDs) and communication media. Communication media may include any one or more of wired communication media such as copper wire, coaxial cable and optical fiber, as well as wireless communication media such as electromagnetic media including radio, microwave, infra-red and laser light. In an embodiment of the invention, computer-readable media is tangible.

For clarity, embodiments of the invention may be described herein with reference to symbolic operations such as those of a computer programming language. Such symbolic operations and any data that they act upon correspond to physical states of components and changes in components of computing devices such as the computers 102, 104, 106, 108 in a manner well understood by one of skill in the art. In an embodiment of the invention, each such operation and its associated data may be fully implemented in hardware.

The network 110 may include any suitable network element and/or communication media. A computing device is an example of a suitable network element. The network 110 may incorporate any suitable network topology. Examples of suitable network topologies include simple point-to-point, star topology, self organizing peer-to-peer topologies and combinations thereof. Furthermore, the network 110 may employ any suitable network protocol to establish and/or maintain connectivity between the computers 102, 104, 106, 108. Examples of suitable network protocols include transmission control protocols (TCP), and internet protocols (IP), and suitable combinations thereof.

Computer facilitated communication providers may operate one or more servers such as servers 102, 104 to facilitate communication among clients such as the clients 106, 108. Even in serverless, peer-to-peer or overlay networks, particular computing devices may be considered as, at times, taking on a server and/or client role. In an embodiment of the invention, clients may publish screened participant class notifications, and servers may parse screened participant class notifications and take action based on screened participant classes. Clients too may parse screened participant class notifications from other clients and take action based on screened participant classes, however, client functionality in this respect is typically some subset of server functionality.

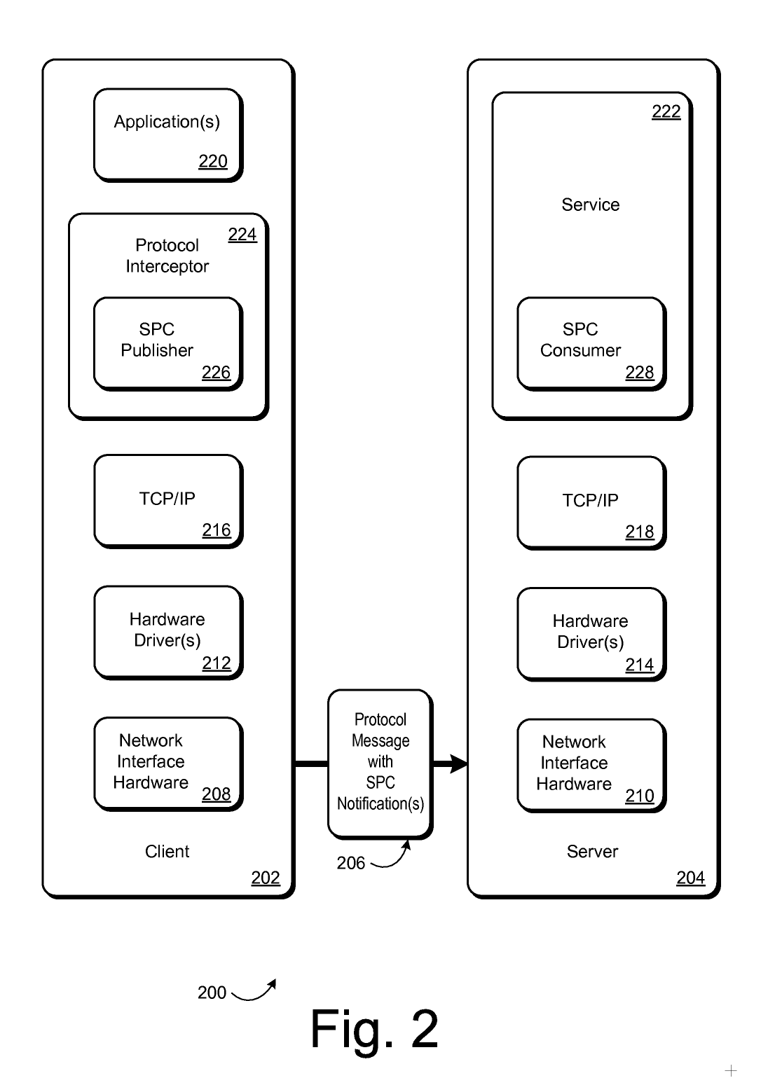

FIG. 2 depicts an example high level screened participant class notification architecture 200 in accordance with an embodiment of the invention. The architecture 200 includes a client 202 and a server 204. Clients 106, 108 (FIG. 1) are suitable examples of the client 202. Servers 102, 104 are suitable examples of the server 204. The client 202 and server 204 may communicate, for example, through a network such as the network 110. Communication between the client 202 and the server 204 may include exchange of communication protocol messages such as the protocol message 206. Communication protocol messages such as the protocol message 206 may participate in any suitable communication protocol including a protocol for screened participant class notification (i.e., a screened participant class notification protocol), a hypertext transfer protocol (HTTP), a simple object access protocol (SOAP), a streaming media protocol, and suitable combinations thereof.

The client 202 and the server 204 may include components corresponding to layers of a protocol stack such as layers in accordance with the International Organization for Standardization (ISO) Open Systems Interconnection (OSI) Basic Reference Model as described by Hubert Zimmermann, “OSI Reference Model—The ISO Model of Architecture for Open Systems Interconnection,” IEEE Transactions on Communications, April 1980. For example, both the client 202 and the server 204 may include a network interface hardware component 208, 210 that provides a physical interface to the network 110 (FIG. 1), one or more hardware drivers 212, 214 that present a computer operating system (and components thereof) with a standardized interface to the network interface hardware component 208, 210, a transmission control protocol and internetworking protocol (TCP/IP) component 216, 218 that utilizes the hardware driver(s) 212, 214 to provide higher level networking services to the computer operating system (and components thereof), as well as one or more applications 220 or services (i.e., server-side applications) such as the service 222.

In addition, the client 202 may include a protocol interceptor 224 capable of intercepting outgoing protocol messages. In the example depicted in FIG. 2, the protocol interceptor 224 is located between the application(s) 220 and the TCP/IP component 216, however each embodiment of the invention is not so limited and the protocol interceptor may be located at any suitable protocol message interception point. In particular, the protocol interceptor 224 may be incorporated into protocol stack components such as the TCP/IP component 216, the hardware driver(s) 212 and/or the network interface hardware 208.

The protocol interceptor 224 may determine which intercepted protocol messages are capable of and/or suitable for incorporating a screened participant class notification. If the protocol interceptor 224 determines that a particular protocol message is a candidate for incorporating a screened participant class notification, the protocol interceptor 224 may pass the protocol message to a screened participant class (SPC) publisher 226 for further processing. Alternatively, the protocol interceptor 224 may pass each intercepted protocol message to the screened participant class publisher 226, and the screened participant class publisher 226 may determine if the protocol message is capable of and/or suitable for incorporating a screened participant class notification.

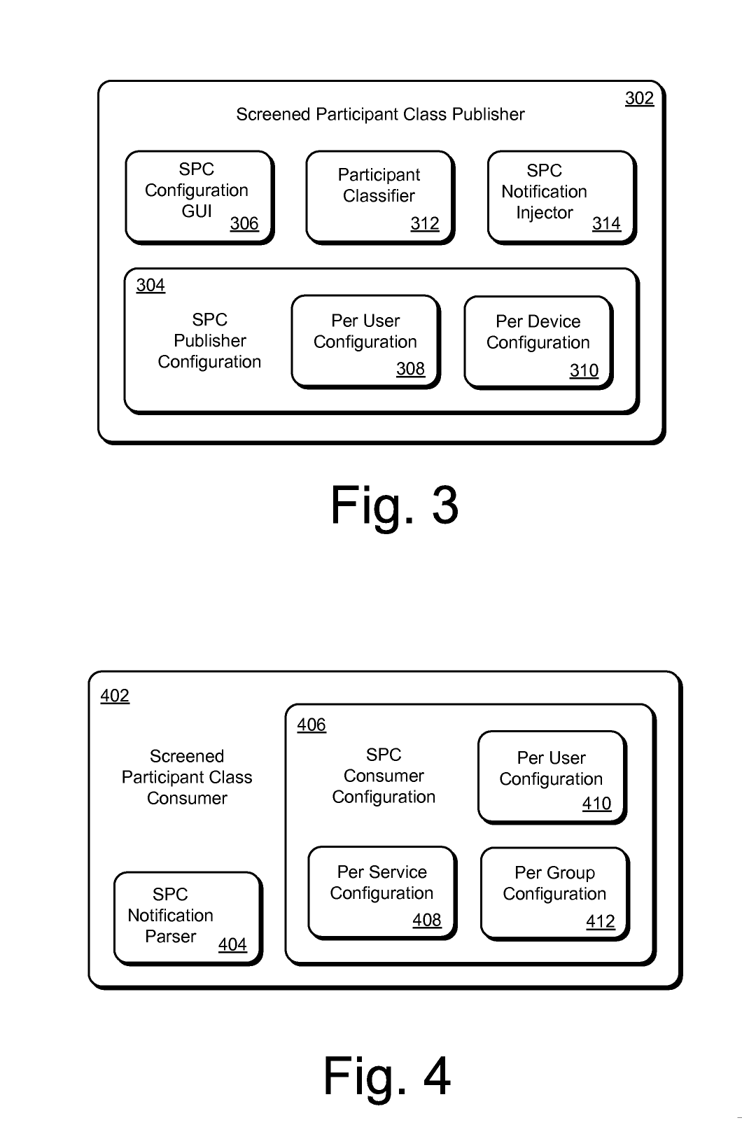

The screened participant class publisher 226 may publish screened participant classes. For example, the screened participant class publisher 226 may publish screened participant classes by modifying a suitable protocol message so that the protocol message incorporates one or more screened participant class notifications corresponding to the screened participant classes. In particular, the screened participant class publisher 226 may inject one or more screened participant class notifications into a protocol message intercepted by the protocol interceptor 224. Example screened participant class publishers in accordance with an embodiment of the invention are described below in more detail with reference to FIG. 3.

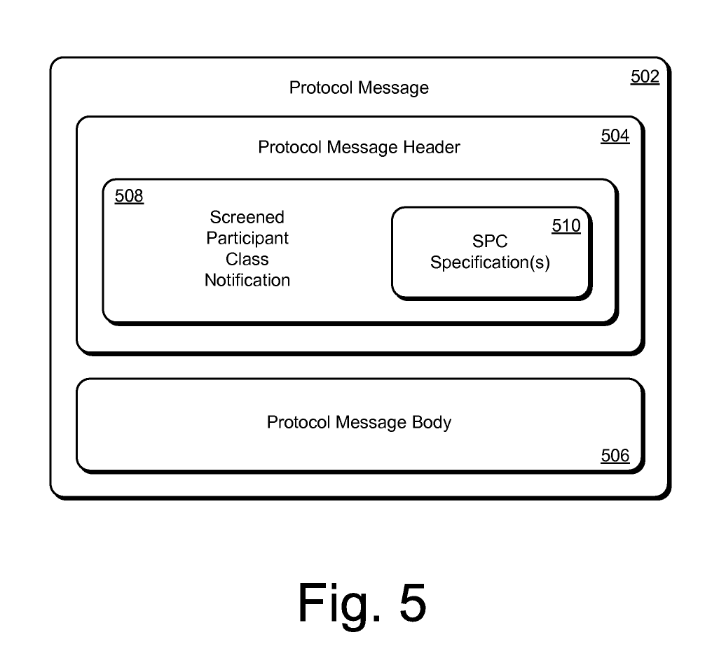

In the example depicted in FIG. 2, the protocol message 206 has been injected with one or more screened participant notifications by the screened participant class publisher 226 and is in transit between the client 202 and the server 204 as depicted by the associated arrow. The arrow's direction from the client 202 to the server 204 merely highlights the direction of travel of the protocol message 206 in this example and, in particular, does not preclude protocol messages of the same or similar type traveling in the reverse direction. Examples of protocol messages incorporating screened participant class notifications in accordance with an embodiment of the invention are described below in more detail with reference to FIG. 5.

Upon arrival at the server 204, the protocol message 206 may be passed up the protocol stack to the service 222 to which it is addressed. The service 222 may determine whether or not the protocol message 206 includes any screened participant class notifications and, if it does, may pass the protocol message 206 to a screened participant class consumer 228 for further processing. Alternatively, the service 222 may pass each suitable incoming protocol message to the screened participant class consumer 228, and the screened participant class consumer 228 may detect and/or parse any screened participant class notifications 228 incorporated in the protocol message 206.

The screened participant class consumer 228 may determine one or more screened participant classes associated with one or more screened participant class notifications in the protocol message 206. The screened participant class consumer 228 may make the determined screened participant classes immediately available to the service 222. The screened participant class consumer 228 may make the determined screened participant classes available for a time period (e.g., until a next protocol message arrives), or on a permanent basis. Although typically it is the service 222 that associates determined screened participant classes with particular communication sessions, participants and/or groups, the screened participant class consumer 228 may perform aspects of these functions, in particular, creation, deletion and/or update of screened participant class records and/or sets of screened participant classes stored in a database. Example screened participant class consumers in accordance with an embodiment of the invention are described below in more detail with reference to FIG. 4.

Screened participant classes published by the screened participant class publisher 226 are typically configured by a user of the client 202 (e.g., a communication participant and/or a legal guardian of the communication participant). The screened participant class publisher 226 may manage such configuration and/or provide a configuration mechanism. FIG. 3 depicts example details of a screened participant class publisher 302 in accordance with an embodiment of the invention. The screened participant class publisher 302 is a suitable example of the screened participant class publisher 226 of FIG. 2.

The screened participant class publisher 302 may include screened participant class (SPC) publisher configuration 304, for example, capable of being persisted in a computer readable medium. The screened participant class publisher 302 may further include a screened participant class (SPC) configuration graphical user interface (GUI) 306 capable of facilitating user modification of the screened participant class publisher configuration 304. The screened participant class configuration graphical user interface 306 may incorporate any suitable graphical user interface element. In particular, the screened participant class configuration graphical user interface 306 may present a user of the client 202 with one or more representations of one or more screened participant classes from which the user may select.

The screened participant class publisher 302 may be configured on a per user and/or per device basis, and the screened participant class publisher configuration 304 may include explicit per user configuration 308 and per device configuration 310 modules for that purpose. A hierarchy may be established between the configurations, for example, per device configuration 310 settings may override per user configuration 308 settings or vice versa, configuration settings of particular users may override those of others, and/or combinations thereof. A typical scenario in which such a configuration hierarchy may be employed is where the device is a family computer that facilitates communication for a variety of persons of differing ages and/or subject matter sensitivities. For example, it may be that notification of a sensitivity to hate speech is configured for the device and all users thereof, with biographic details and supplemental sensitivities configured on a per user basis.

Biographic details that may be configured with the screened participant class configuration graphical user interface 306 include age (including date of birth), age range, age group, age category, age label, age description, race, racial group, racial category, ethnicity, ethnic group, ethnic category, gender, gender category, religion, religious group, religious category, national origin, national group, national category, physical or mental disability, disability group, disability category, height, height group, height category, literacy, literacy group, literacy category, native language, language group, language category, marital status, familial status, sexual preference, and/or any suitable biographic detail, in particular those associated with a legal status.

Subject matter sensitivities may be configured independently of biographic details. Subject matter sensitivities that may be configured with the screened participant class configuration graphical user interface 306 include violence, violence category (e.g., animated, animal, human), sexual material, sexual material category (e.g., implied, explicit), nudity, nudity category (e.g., partial, full frontal), objectionable language, objectionable language category (e.g., imprecation, profanity), horror, mature content, user generated content or “chat”, user generated content category (e.g., moderated, unmoderated), vice, vice category (e.g., alcohol use, tobacco use, drug use, gambling, pornography), weapon use, bomb manufacture and use, hate speech, and any suitable subject matter sensitivity. One or more contexts in which particular subject matter sensitivities are ameliorated or exacerbated may also be configured with the screened participant class configuration graphical user interface 306. Example contexts include artistic, educational, medical, sports and news.

The set of screened participant classes published by the screened participant class publisher 302 and/or an extent to which biographic details and/or subject matter sensitivities are screened may depend upon a level of trust between communication participants. The screened participant class publisher 302 may include a participant classifier 312 to determine the level of trust associated with a particular communication participant. The participant classifier 312 may determine the level of trust based on assessments by conventional content control mechanisms, communication history (including duration and volume), evaluations in the context of conventional trust networks (including certification hierarchies as well as peer-to-peer trust networks), explicit user designation, and/or any suitable trust evaluation mechanism. For example, the level of trust may correspond to a trust score, a trust category, and suitable combinations thereof.

The screened participant class configuration graphical user interface 306 may be utilized to designate trust levels at which different levels of biographic detail and/or subject matter sensitivity screening occur. Screening levels may range from no screening (i.e., always published at the highest level of specificity) to complete screening (i.e., never published regardless of trust level). Examples of intermediate screening levels include obscuring to group and category levels, particularly using labels (e.g., “young child,” “preteen,” “teen,” “adult”) instead of numbers, as well as utilizing ranges of varying (and at times deliberately obscuring) specificity, particularly with respect to age ranges. Ranges including both a minimum and a maximum (e.g., “participant is 11-13 years old”) may be considered more specific than ranges including only a minimum or a maximum (e.g., “participant is under 18”).

The screened participant class configuration graphical user interface 306 may include multiple configuration modes such as basic, intermediate and advanced. Each configuration mode may be associated with a set of graphical user interface elements such as windows, dialogs and menus. Each configuration mode may offer some subset of the configuration options described above. Each configuration mode may have an associated set of configuration defaults.

The screened participant class publisher 302 may further include a screened participant class notification injector 314. The screened participant class notification injector 314 may assess protocol messages provided to the screened participant class publisher 302 for suitability with respect to incorporating screened participant class notifications. For example, suitability in this respect may be based on protocol message type and/or one or more protocol message attributes. The screened participant class notification injector 314 may determine a candidate set of screened participant classes for publication in a particular protocol message based on the protocol message and the screened participant class publisher configuration 304, including per device configuration 310 and per user configuration 308. The candidate set of screened participant classes may be filtered and/or transformed based on a participant classification, and in particular a trust level, provided by the participant classifier 312 as well as the screened participant class publisher configuration 304.

The screened participant class notification injector 314 may further determine a set of screened participant class notifications corresponding to the candidate set of screened participant classes. The screened participant class notification injector 314 may inject the set of screened participant class notifications into the protocol message. Injection of the set of screened participant class notifications may include suitably formatting the set of screened participant class notifications as well as modifying the protocol message, including rewriting portions of the protocol message such as a protocol message header.

The screened participant class consumer 228 (FIG. 2) at the server 204 may parse incoming protocol messages for screened participant class notifications and determine corresponding screened participant classes. FIG. 4 depicts example details of a screened participant class consumer 402 in accordance with an embodiment of the invention. The screened participant class consumer 402 is a suitable example of the screened participant class consumer 228.

The screened participant class consumer 402 may include a screened participant class notification parser 404 capable of parsing screened participant class notifications and determining corresponding screened participant classes. The screened participant class consumer 402 may further include a screened participant class consumer configuration 406 capable of configuring the screened participant class consumer 402. For example, parsing of screened participant class notifications and subsequent handling of corresponding screened participant classes may be based on the screened participant class consumer configuration 406. The screened participant class consumer configuration 406 may include explicit per service configuration 408, per user configuration 410 and per group configuration 412.

For example, the service 222 (FIG. 2) may be a gateway to multiple service types such as a search engine, hypertext document server or other media servers including servers of streaming audio and video, as well as discussion group services or other collaborative environments including conventional telecommunications gateways, multiplayer games, “virtual reality” environments, and so on. The per service configuration 408 may configure the screened participant class consumer 402 to behave differently for each service type to which the service 222 provides access. For example, the per service configuration 408 may specify how screened participant class information is managed on a per service basis and in particular may specify a minimum and/or maximum screened participant class specificity to provide to each service and/or service type, including that no screened participant class information is to be provided to a particular set of services and/or service types. In addition, the screened participant class consumer 402 may be configured to provide different screened participant class related services for different service types including actions based on screened participant classes (“screened participant class actions”) that may be specified with any suitable scripting and/or programming language.

The per user configuration 410 of the screened participant class consumer 402 may be utilized to provide a common screened participant class information database to multiple service types. For example, the per user configuration 410 may specify how screened participant class information is managed on a per user basis. For one set of users, screened participant class information may be available only for a specified period of time after first provided. For another set of users, screened participant class may be persisted indefinitely with updating based on screened participant class notifications published by users as well as, for example, tracking of changes to sets of screened participant classes associated with users. In particular, a maximum screened participant class specificity to reveal may be specified on a per user basis including that no screened participant class information be provided for a particular set of users.

Service 222 (FIG. 2) users may be organized into and/or associated with one or more groups. In particular, service 222 users may participate in one or more discussion and/or otherwise collaborative groups. The per group configuration 412 may specify how screened participant class information is managed on a per group basis and, in particular, may specify a minimum and/or maximum screened participant class specificity required by each group and/or group type. In addition, the screened participant class consumer 402 may implement group access control based on the per group configuration 412, for example, permitting or denying access to group resources based on a requester's associated screened participant classes. The per group configuration 412 may further specify actions to take based on access control decisions, for example, in case access is denied to a particular group, the per group configuration 412 may specify whether and/or how alternate group access is provided.

The protocol message 206 (FIG. 2) may have structure facilitating injection by the screened participant class publisher 226 and/or parsing by the screened participant class consumer 228. FIG. 5 depicts an example protocol message 502 structure in accordance with an embodiment of the invention. The protocol message 502 is a suitable example of the protocol message 206. The protocol message 502 may include a protocol message header 504 and a protocol message body 506. The protocol message header may include a screened participant class notification 508, and the screened participant class notification 508 may include one or more screened participant class specifications 510.

Although only one protocol message header 504 section is shown in FIG. 5, the protocol message 502 may include multiple header sections, and the screened participant class notification 508 may be injected into any suitable protocol message header. Although the example depicted in FIG. 5 shows the screened participant class notification 508 as having been injected into the protocol message header 504, each embodiment of the invention is not so limited, for example, the screened participant class notification 508 may be injected into the protocol message body 506 and/or the protocol message body 506 may be the screened participant class notification 508. Nevertheless, in an embodiment of the invention, it is advantageous (e.g., efficient) for the screened participant class notification 508 to be injected into the protocol message header 504, particularly where the protocol message 502 participates in an established computer facilitated communication protocol.

As a more specific example, the protocol message 502 may be a message of a hypertext transfer protocol (HTTP), and the protocol message header 504 may include any suitable aspect of a conventional hypertext transfer protocol message header. The injected screened participant class notification 508 and/or the screened participant class specification(s) may include one or more name-value pairs and appropriate delimiters. For example, a particular screened participant class specification may include an attribute name corresponding to an age range such as “Age-Range” and an attribute value corresponding to the age range such as “Preteen” separated by alphanumeric delimiters such as a colon and a space. Such attribute names and/or values may be specified with any suitable specification language and/or format, in particular age ranges may be specified with text labels and/or any suitable numeric range specification.

The screened participant class notification 508 may be adapted to be as simple as possible with respect to the protocol message 502 and/or the protocol message header 504, or the screened participant class notification 508 may have a more sophisticated structure. For example, the screened participant class notification 508 may be adapted by the screened participant class publisher 226 (FIG. 2) to take advantage of a native protocol message 502 and/or protocol message header 504 extension mechanism, to reduce additional protocol overhead and/or to assume associated context is maintained at the screened participant class consumer 228 by mechanisms other than the screened participant class notification 508. Where more sophisticated structures are appropriate, for example, where such assumptions about associated context may not be valid, the screened participant class notification 508 may further include, for example, device and/or user identifiers, or other suitable context and/or context association information, as well as system change management information such as version identifiers for screened participant class notification 508 and/or screened participant class specification 510 formats.

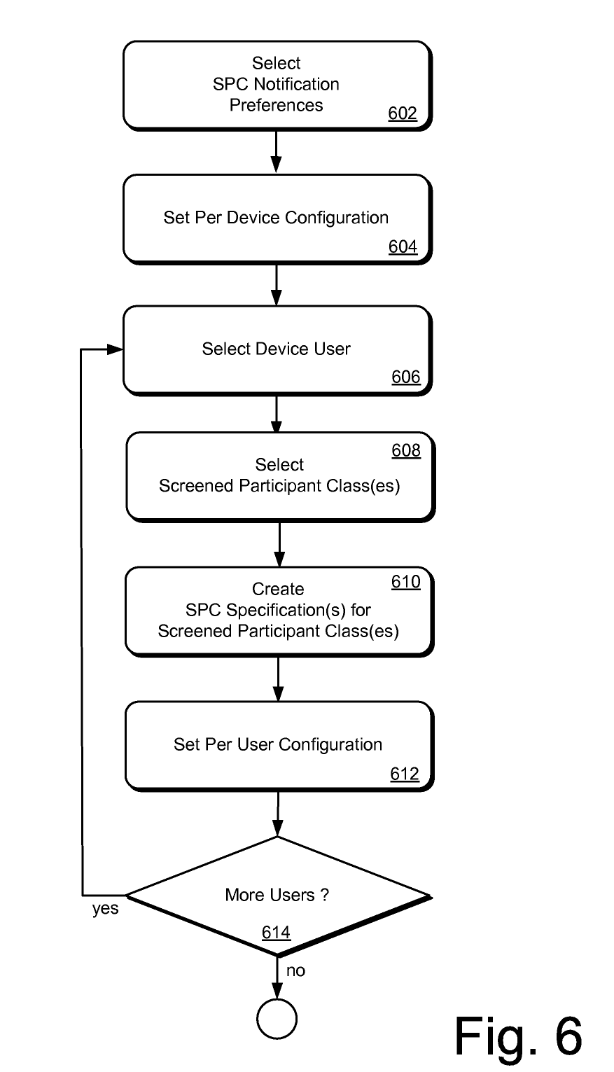

Having described structural aspects of the screened participant class notification architecture 200 (FIG. 2), the description now turns to procedures and steps thereof that may be performed by components of the screened participant class notification architecture 200. FIG. 6 depicts example steps for configuring the screened participant class publisher 302 (FIG. 3) in accordance with an embodiment of the invention.

At step 602, screened participant class notification preferences may be selected. For example, screened participant class notification preferences may be selected with the screened participant class configuration graphical user interface 306 (FIG. 3). In particular, screened participant class preferences corresponding to per device configuration 310 may be selected at step 602, for example, administrative settings, user default preferences, and device-wide subject matter sensitivities. At step 604, per device configuration 310 may be set. For example, the screened participant class publisher 302 may set the per device configuration 310 based on the selections made at step 602.

Each device may have multiple users and, at step 606, a particular device user may be selected, for example, with the screened participant class configuration graphical user interface 306 (FIG. 3). At step 608, one or more screened participant classes may be selected. The screened participant class configuration graphical user interface 306 may include one or more dialogs enabling efficient selection of screened participant classes and association with the selected device user. For example, the selection may be performed by the device user and/or a device administrator.

At step 610, screened participant class specifications may be created for the selected screened participant classes. For example, the screened participant class publisher may create the screened participant class specifications based on the selections made at step 608. At step 612, the per user configuration 308 (FIG. 3) may be set. For example, the screened participant class specifications created at step 610 may be stored in the per user configuration 308 associated with the device user selected at step 606. Alternatively, screened participant classes (as contrasted with screened participant class specifications) may be stored in the per user configuration 308, and creation of screened participant class specifications suitable for incorporating into the screened participant class notification 508 (FIG. 5) may be delayed until nearer a time of injection.

At step 614, it may be determined if there are more device users to configure. If there are more device users to configure, a procedure incorporating steps depicted by FIG. 6 may return to step 606. Otherwise, the procedure may progress to steps other than those depicted in FIG. 6.

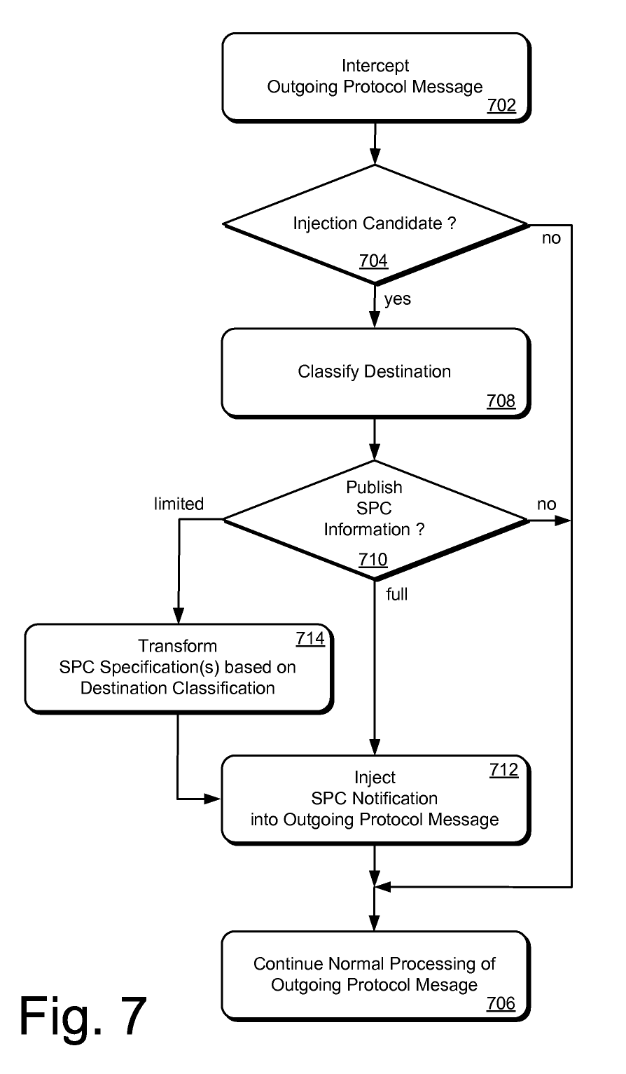

Once configured, the screened participant class publisher 302 (FIG. 3) may wait for outgoing protocol messages to consider as publication candidates. FIG. 7 depicts example steps for publishing screened participant class notifications in accordance with an embodiment of the invention. At step 702, an outgoing protocol message such as the protocol message 502 (FIG. 5) may be intercepted. For example, the protocol interceptor 224 (FIG. 2) may intercept an outgoing protocol message sent by one of the applications 220. The screened participant class publisher 302 may receive each protocol message intercepted by the protocol interceptor 224, or the screened participant class publisher 302 may subscribe to a subset of the intercepted protocol messages.

At step 704, it may be determined if the intercepted protocol message is a candidate for screened participant class notification injection. The intercepted protocol message may be rejected as an injection candidate for several reasons. For example, the protocol message may not be a recognized type, the protocol message may be of a type recognized as not injectable, the protocol message may be part of a communication session in which screened participant class information has already been published and/or in which republishing is inappropriate, or the protocol message may be rejected based on the screened participant class publisher configuration 304 (FIG. 3) including rules-based filtering. If the protocol message is rejected as an injection candidate, a procedure incorporating steps depicted in FIG. 7 may progress to step 706 to continue with normal processing of the outgoing protocol message. Otherwise, the procedure may progress to step 708.

Each outgoing protocol message may be addressed to a recipient. In the context of screened participant class publishing, the recipient may be considered as a computer facilitated communication participant. At step 708, the protocol message destination (i.e., recipient) may be classified. For example, the participant classifier 312 (FIG. 3) may classify the protocol message destination and, in particular, the participant classifier 312 may determine a level of trust associated with the protocol message destination.

At step 710, it may be determined if screened participant class information should be published. For example, the screened participant class publisher 302 (FIG. 3) may determine if screened participant class information should be published based on the destination classification determined at step 708 and/or the screened participant class publisher configuration 304. It may be determined that no screened participant class information should be published, for example if the destination is untrusted, in which case the procedure may progress to step 706. It may be determined that full (or default) screened participant class information should be published, for example if the destination is trusted, in which case the procedure may progress to step 712. In addition, it may be determined that limited (or partial) screened participant class information should be published, for example if only limited trust has been established with the destination, in which case the procedure may progress to step 714.

At step 714, the configured screened participant class specification(s) may be transformed based on the protocol message destination classification. For example, the screened participant class specification(s) created at step 610 (FIG. 6) may be transformed based on the destination classification determined at step 708. In particular, the screened participant class specification(s) may have their specificity reduced in accordance with a level of trust associated with the protocol message destination.

At step 712, the screened participant class notification 508 (FIG. 5) may be injected into the outgoing protocol message. For example, the screened participant class notification injector 314 (FIG. 3) may inject the screened participant class notification 508 into the outgoing protocol message by modifying the headers of the outgoing protocol message to include the screened participant class notification 508. The screened participant class specification(s) 510 included in the screened participant class notification 508 may be those created at step 610 (FIG. 6) and/or modified at step 714. At step 706, the outgoing protocol message may be further processed for dispatch in a conventional manner.

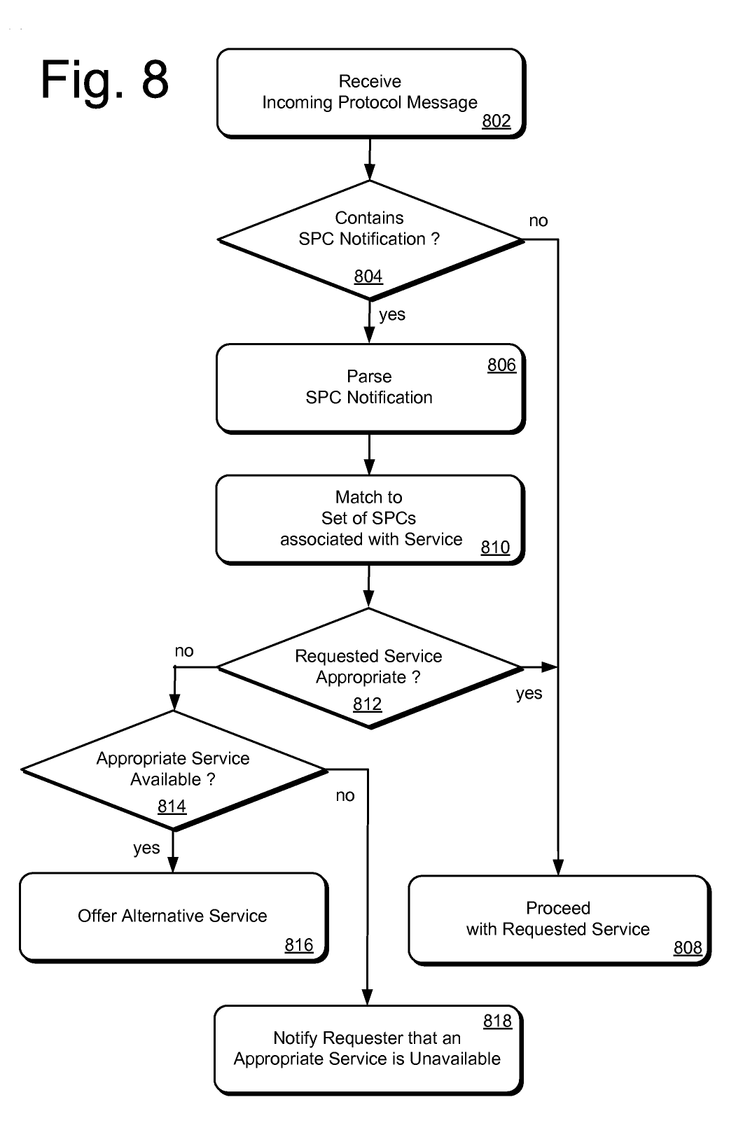

The protocol message 206 (FIG. 2) carrying the injected screened participant class notification 508 (FIG. 5) may then travel to its destination, for example, a computer facilitated communication service such as the service 222 incorporating a screened participant class consumer 228. One use of screened participant class(es) is for service access control. FIG. 8 depicts example steps for service access control based on screened participant class(es) in accordance with an embodiment of the invention.

At step 802, an incoming protocol message such as the protocol message 502 (FIG. 5) may be received. For example, the screened participant class consumer 402 (FIG. 4) may receive the protocol message 502. The screened participant class consumer 402 may receive each incoming protocol message for inspection or, if the service 222 includes appropriate facilities, the screened participant class consumer 402 may subscribe to a subset of the incoming protocol messages. At step 804, it may be determined if the incoming protocol message contains a screened participant class notification such as the screened participant class notification 508. If the protocol message 502 does contain the screened participant class notification 508, a procedure incorporating steps depicted in FIG. 8 may progress to step 806. Otherwise, the procedure may progress to step 808.

At step 806, the screened participant class notification 508 (FIG. 5) may be parsed. For example, the screened participant class notification parser 404 (FIG. 4) may parse the screened participant class notification 508 and determine one or more screened participant classes corresponding to the screened participant class specification(s) 510. For example, the screened participant class notification parser 404 may instantiate one or more in-memory (or in-database) screened participant class objects corresponding to name-value pairs in the protocol message header 504.

At step 810, the screened participant class(es) parsed from the screened participant class notification at step 806 may be matched to a set of screened participant classes associated with a destination service (e.g., the computer facilitated communication service to which the incoming protocol message is addressed). For example, the screened participant class consumer 402 per service configuration 408 may include a set of screened participant classes associated with the destination service and the parsed screened participant class(es) may be matched against that set. The screened participant class consumer 402 may utilize any suitable matching scheme. Both positive matches and negative matches (i.e., non-matches) may be significant.

At step 812, it may be determined if the requested service (i.e., the destination service) is appropriate with respect to the parsed screened participant class(es). For example, the matching of step 810 may yield a binary result (i.e., match or else no match) and the determination may be based on the binary result, or the matching of step 810 may result in a score and the determination may be based on comparison of the score with a threshold specified in the per service configuration 408 (FIG. 4). If it is determined that the requested service is appropriate in light of the parsed screened participant class(es), the procedure may progress to step 808. Otherwise, the procedure may progress to step 814.

At step 814, it may be determined if an appropriate alternative service is available. For example, the per service configuration 408 (FIG. 4) may specify a set of alternative services for each service, and the screened participant class consumer 402 may perform a matching step similar to step 810 to find an appropriate service in the set of alternative services or else determine that no appropriate alternative is available. Where the matching results in a score, a most appropriate (e.g., highest scoring) alternative may be determined at step 814. If it is determined that one or more appropriate alternatives are available, the alternative service(s) (and/or the most appropriate alternative service) may be offered to the requester at step 816. Otherwise, the requester may be notified at step 818 that an appropriate service is unavailable.

Although the screened participant class consumer 402 may be configured to respond directly to the requester with offers of alternative services and/or notifications that an appropriate service is unavailable, typically the screened participant class consumer 228 (FIG. 2) notifies the service 222 of the result of the steps depicted in FIG. 8, and the service 222 handles further interaction with the requester. For example, the protocol message 206 may participate in a hypertext transfer protocol, the service 222 may incorporate a hypertext transfer protocol (“web”) server and, in response to the result determined by the steps depicted in FIG. 8, the web server may respond with a web page offering alternative services or notifying the requester that an appropriate service is unavailable. At step 808, the service 222 may proceed to provide the requested service as normal.

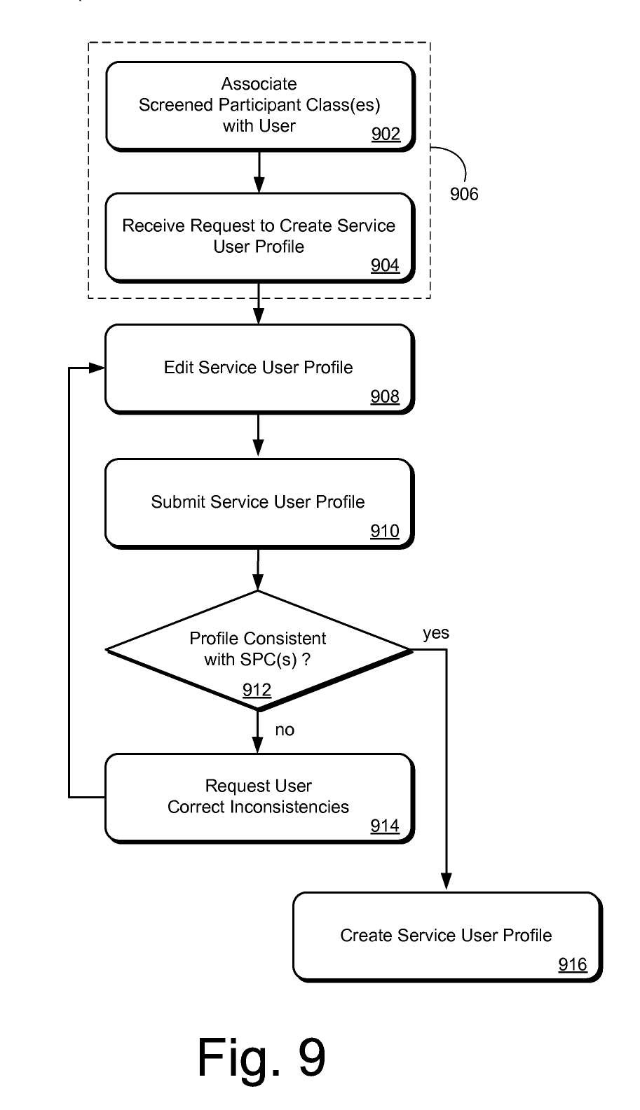

Another use of screened participant class(es) is to verify consistency of a profile created for a service. FIG. 9 depicts example steps for profile consistency verification based on screened participant class(es) in accordance with an embodiment of the invention. At step 902, one or more screened participant classes may be associated with a service user. For example, the service 222 (FIG. 2) may associate a set of screened participant classes received from the screened participant class consumer 228 with a particular service user. Alternatively, associations between screened participant classes and users may be maintained by the screened participant class consumer 228, and the associations may be requested from the screened participant class consumer 228 by the service 222 as required.

At step 904, a request to create a service user profile may be received. For example, the service 222 (FIG. 2) may receive such a request from a user of the client 202. Steps 902 and 904 are grouped by dashed line 906 to indicate that steps 902 and 904 may be integral. For example, the request to create a user profile may include one or more screened participant class notifications such as the screened participant class notification 508 (FIG. 5). However, it is possible for the server-side association of a particular service user with one or more screened participant classes to occur far in advance of the request to create a service profile and this occurrence may even be advantageous in that the service 222 may, for example, disallow the establishment of certain service profiles thus avoiding the issue of consistency altogether.

At step 908, a service user profile may be edited. For example, a user of the client 202 (FIG. 2) may utilize a hypertext transfer protocol client (e.g. a “web browser”) application 220 to edit a profile form provided by a web server incorporated into the service 222. In particular such profiles may require the entry of biographic details. At step 910, the edited service user profile may be submitted. For example, the web browser may submit the edited profile form to the web server for processing by the service 222. It is possible for server-side associations of screened participant classes to the user to occur during steps 908 and 910 as well.

At step 912, it may be determined if the submitted service user profile is consistent with the set of screened participant classes associated with the user. In particular, some screened participant classes associated with the user may specify biographic details and the service 222 (FIG. 2) may check that the biographic details submitted by the user are consistent with those screened participant classes. For example, if the submitted service user profile included an age of 18 years while a screened participant class associated with the user specified that the user was a preteen, then the submitted service user profile may be determined inconsistent. If the submitted user service profile is determined to be inconsistent then a procedure incorporating steps depicted in FIG. 9 may progress to step 914. Otherwise, the procedure may progress to step 916.

At step 914, it may be requested that the user correct any inconsistencies. For example, following submission of an inconsistent service user profile form, the web server incorporated into service 222 (FIG. 2) may return a web page highlighting any inconsistencies and requesting that the user correct them. Once the submitted service user profile is consistent with the set of screened participant classes associated with the submitting user, at step 916, the user service profile may be created.

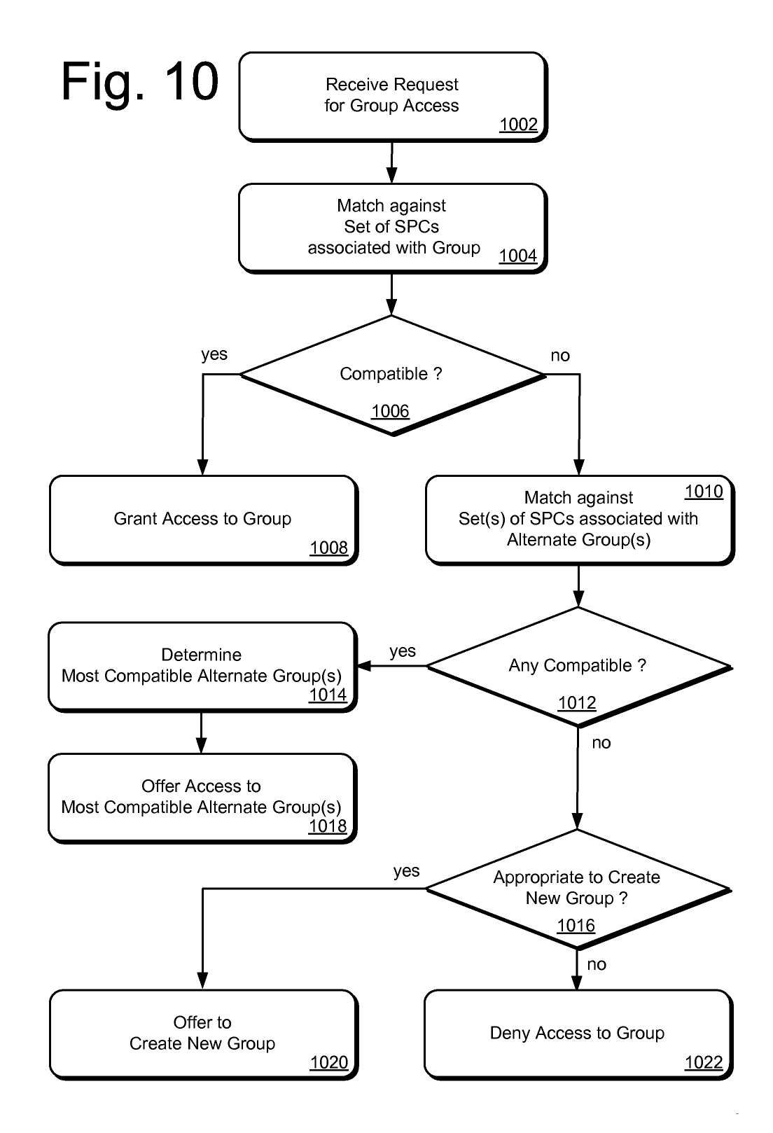

Still another use of screened participant class(es) is to facilitate a new discussion participant joining an appropriate discussion group and/or prevent the new discussion participant from joining an inappropriate discussion group. FIG. 10 depicts example steps for facilitated group joining based on screened participant classes in accordance with an embodiment of the invention. At step 1002, a request may be received to access a particular group. For example, the service 222 (FIG. 2) may receive a request to join a discussion group hosted by the service 222.

At step 1004, a set of screened participant classes associated with the user making the group access request may be matched against a set of screened participant classes associated with the group. For example, the service 222 (FIG. 2) and/or the screened participant class consumer 228 may have previously associated a set of screened participant classes with the user, or the group access request may include one or more screened participant class notifications such as the screened participant class notification 508 (FIG. 5), and the service 222 may match that set against a set of screened participant class associated with the group. The service 222 may utilize functionality provided by the screened participant class consumer 402 (FIG. 4) to match screened participant class sets, and the set of screened participant classes associated with the group may be stored in the per group configuration 412 of the screened participant class consumer 402. The set of screened participant classes associated with a particular group may be based on sets of screened participant classes associated with current members of the group.

At step 1006, it may be determined if the set of screened participant classes associated with the user making the access request is compatible with the set of screened participant classes associated with the group. For example, the assessment of compatibility may be based on the matching of step 1004. As described above with reference to step 810 of FIG. 8, the matching may yield a binary result or a score and, accordingly, the determination of step 1006 may be a binary determination or require comparison of the set matching score with a threshold. This threshold may be specified on a per group basis, for example, in the per group configuration 412 (FIG. 4) of the screened participant class consumer 402. If it is determined that the sets of screened participant classes are compatible, the user may be granted access to the group at step 1008. Otherwise, a procedure incorporating steps depicted in FIG. 10 may progress to step 1010.

At step 1010, the set of screened participant classes associated with the user requesting group access may be matched against one or more sets of screened participant classes associated with one or more alternate groups. At step 1012, it may be determined whether any of the possible alternate groups meet a criteria of compatibility in a manner similar to that described for step 1006. If one or more of the alternate groups are determined to be compatible, the procedure may progress to step 1014. Otherwise, the procedure may progress to step 1016.

At step 1014, one or more most compatible alternate groups may be determined. For example, if the matching of step 1010 results in compatibility scores, the alternate groups may be ranked according to the compatibility score and those with a score above a threshold may be determined to be most compatible and/or a particular (maximum) number of alternate groups with the highest score may be determined to be most compatible. At step 1018, the requesting user may be offered access to the set of most compatible alternate groups.

At step 1016, where no existing compatible alternate groups have been found, it may be determined whether it is appropriate to create a new group. For example, the set of screened participant classes associated with the user requesting group access may be compatible with a particular discussion group topic, but other discussion groups on the topic have included group members with incompatible screened participant classes (e.g., incompatible age ranges). If it is appropriate to create a new group the procedure may progress to step 1020 and offer to create the new group. Otherwise, the procedure may progress to step 1022 and indicate that the request for group access has been denied.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to an embodiment of the invention.

Preferred embodiments of the invention are described herein, including the best mode known to the inventors for carrying out the invention. Variations of those preferred embodiments may become apparent to those of ordinary skill in the art upon reading the specification. The inventors expect skilled artisans to employ such variations as appropriate, and the inventors intend for the invention to be practiced otherwise than as explicitly described herein. Accordingly, embodiments of the invention include all modifications and equivalents of the subject matter recited in the following claims as permitted by applicable law.

1. At least one computer-readable medium having thereon computer-executable instructions for screened participant class notification comprising:
selecting a screened participant class from a set of screened participant classes;
intercepting a protocol message; and
injecting a screened participant class notification corresponding to the screened participant class into the protocol message.

2. Said at least one computer-readable medium of claim 1, wherein the screened participant class corresponds to an age range.

3. Said at least one computer-readable medium of claim 2, wherein the screened participant class notification comprises an age range specification.

4. Said at least one computer-readable medium of claim 3, wherein the age range specification comprises a minimum age and a maximum age.

5. Said at least one computer-readable medium of claim 3, wherein the age range specification comprises a label corresponding to the age range.

6. Said at least one computer-readable medium of claim 1, wherein the screened participant class corresponds to a subject matter sensitivity.

7. Said at least one computer-readable medium of claim 1, wherein the protocol message is part of a hypertext transfer protocol.

8. Said at least one computer-readable medium of claim 1, wherein the protocol message is part of a streaming media protocol.

9. Said at least one computer-readable medium of claim 1, wherein:
the protocol message comprises a message header and a message body; and
the screened participant class notification is injected into the message header.

10. Said at least one computer-readable medium of claim 1, wherein the screened participant class notification comprises a screened participant class specification specifying the screened participant class.

11. At least one computer-readable medium having thereon computer-executable instructions for screened participant class notification comprising:
receiving a protocol message comprising a screened participant class notification;
parsing at least one screened participant class from the screened participant class notification; and
determining a compatibility of a service with said at least one screened participant class.

12. Said at least one computer-readable medium of claim 11, wherein determining the compatibility comprises matching said at least one screened participant class against a set of screened participant classes associated with the service.

13. Said at least one computer-readable medium of claim 12, wherein determining the compatibility comprises determining that said at least one screened participant class is present in the set of screened participant classes associated with the service.

14. Said at least one computer-readable medium of claim 11, wherein:
the service provides controlled access to a group; and
determining the compatibility comprises matching said at least one screened participant class against a set of screened participant classes associated with the group.

15. Said at least one computer-readable medium of claim 11, wherein:
the service provides controlled access to a plurality of groups each associated with a set of screened participant classes; and
determining the compatibility comprises determining a greatest compatibility between said at least one screened participant class and at least one of the plurality of sets of screened participant classes.

16. Said at least one computer-readable medium of claim 11, wherein:
the service comprises establishing a profile; and
determining the compatibility comprises matching said at least one screened participant class against a set of screened participant classes associated with the profile.

17. At least one computer-readable medium having thereon a message of a protocol for screened participant class notification comprising:
a message header;
a message body; and
a screened participant class notification.

18. Said at least one computer-readable medium of claim 17, wherein the message header comprises the screened participant class notification.

19. Said at least one computer-readable medium of claim 18, wherein the screened participant class notification comprises an age range specification.

20. Said at least one computer-readable medium of claim 17, wherein:
the message of the protocol for screened participant class notification participates in another protocol;
the message is intercepted while participating in the other protocol; and
the intercepted message is injected with the screened participant class notification.
